(19) United States
(12) Patent Application Publication
(10) Pub. No.: US 2009/0234575 A1
(43) Pub. Date: Sep. 17, 2009

(54) NAVIGATION DEVICE AND METHOD

(75) Inventors: LIANG KONG, Shenzhen City (CN); BANG-SHENG ZUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/124,172

(22) Filed: May 21, 2008

(30) Foreign Application Priority Data
Mar. 12, 2008 (CN) 200810300529.X

(51) Int. Cl. G01C 21/00

(52) U.S. Cl. 701/201

(57) ABSTRACT

A navigation device includes a route generator, a travel log recorder, a traveled route generator, and a display module. The route generator is used for generating a route from a current position to a destination based on predetermined mapping data when receiving a route request. The travel log recorder is used for recording a traveled log of the navigation device before receiving the route request. The traveled route generator is configured for generating traveled route information according to the traveled log recorded in the travel log recorder when receiving the route request. The display module is used for displaying the route and the traveled route information simultaneously for guiding a user to the destination. A related navigation method is also provided.

### BACKGROUND

1. Field of the Invention

The present invention relates to satellite navigation devices.

2. Description of Related Art

A navigation device is an electronic product which combines a positioning capability, such as Global Positioning System (GPS), and navigation functions. Conventionally, a navigation device will search for an optimized route between a starting location and a destination point using mapping data. When a route including destination information is requested, a current location of the navigation device is computed according to the GPS satellite signals. Then, the optimized route to the destination is selected according to the starting location and destination point of the mapping data. Finally, navigational information may be visually provided through a display screen.

Referring to FIG. 3, when a user driving a car reaches a crossroad 40, and does not know how to go to destination 44, he/she may input a route request to a navigation device. The navigation device shows a route from the crossroad 40 to the destination 44 labeled by a line 43 on an electronic map. However, the navigation device does not show the exact heading (orientation/positioning) of the car at the crossroad 42. If the user is not familiar with the area, and does not know the orientation, the user may not know whether to turn left, right, go straight, or turn around. The problem also arises when the user is on a straight road and does not know whether or not to go straight ahead or turn around.

Therefore, an improved navigation device and method are needed to address the aforementioned deficiency and inadequacies.

### SUMMARY

A navigation device includes a route generator, a travel log recorder, a traveled route generator, and a display module. The route generator is used for generating a route from a current position to a destination based on predetermined mapping data when receiving a route request. The travel log recorder is used for recording a traveled log of the navigation device before receiving the route request. The traveled route generator is configured for generating traveled route information according to the traveled log recorded in the travel log recorder when receiving the route request. The display module is used for displaying the route and the traveled route information simultaneously for guiding a user to the destination. A related navigation method is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic block diagram of a navigation device in accordance with an exemplary embodiment.

FIG. 2 is a schematic diagram of an electronic map showing a route in accordance with an exemplary embodiment.

FIG. 3 is a schematic diagram of an electronic map showing a route in accordance with the related art.

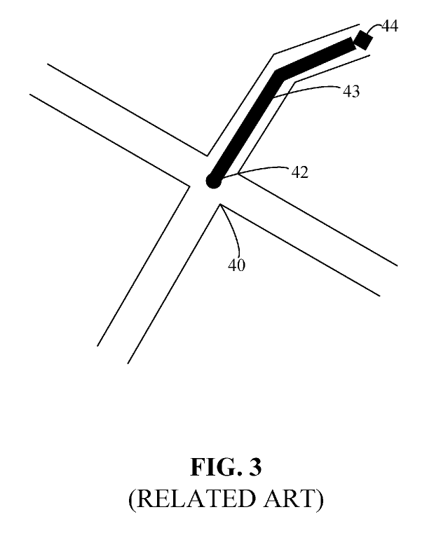

### DETAILED DESCRIPTION OF THE EMBODIMENTS

Reference will now be made to the drawings to describe an exemplary embodiment of the present navigation device and method.

The navigation device records a traveled log before a route request is inputted. When the route request is inputted to the navigation device, the navigation device shows navigational information including the traveled log and a route to a destination simultaneously. Therefore, a better, clearer (more informed) navigational information with respect to the traveled log can be shown/displayed by the navigational device.

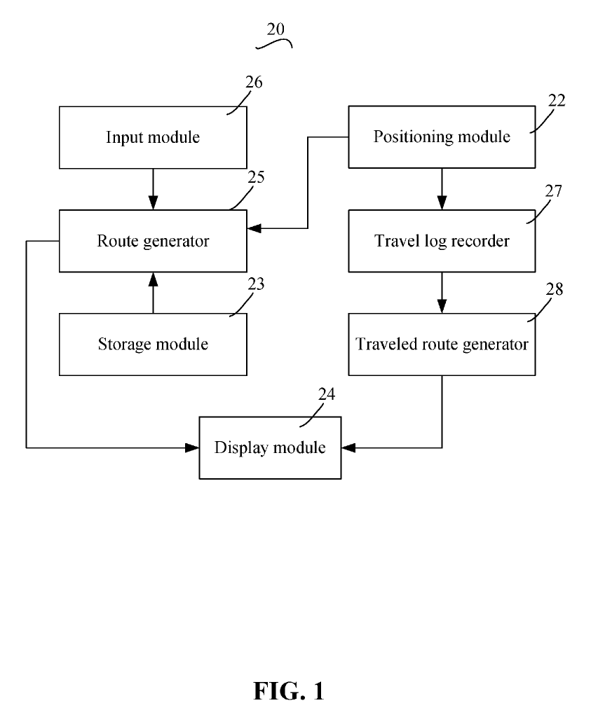

Referring to FIG. 1, a navigation device 20 includes a positioning module 22, a storage module 23, a display module 24, a route generator 25, an input module 26, a travel log recorder 27, and a traveled route generator 28. The storage module 23 is used for storing mapping data.

The positioning module 22 is configured for receiving satellite positioning signals, and determining a current position of the navigation device 20 based on the satellite positioning signals. The satellite positioning signals may be supplied by the Global Positioning System (GPS), or the Global Navigation Satellite Systems (GNSS). Information of the current position of the navigation device 20 includes longitudinal and latitudinal values.

The input module 26 is used for receiving the route request. The route request includes information of the destination. The input module 26 may be a keyboard, a touchscreen, or a handwriting input device (such as a drawing tablet or a tablet-PC).

The route generator 25, coupled to the positioning module 22, the storage module 23, and the input module 26, is used for generating a route according to the mapping data, the current position, and the destination.

The travel log recorder 27 is configured for recording the traveled log of the navigation device 20. In detail, the positioning module 22 generates a current position of the navigation device 20 in real time based on the satellite positioning signals, and the travel log recorder 27 records the current positions at that moment. In the exemplary embodiment, the travel log recorder 27 only keeps the latest traveled record over a predetermined time period. That is, only the traveled log recorded during the predetermined time period of the navigation device 20 is stored in the travel log recorder 27. For example, last fifteen minutes. As a result, storage usage of the travel log recorder 27 is controlled and can be kept to a minimum. In other alternative embodiments, the travel log recorder 27 only keeps the latest traveled record over a predetermined distance, half a mile for example.

The traveled route generator 28 is configured for generating traveled route information according to the traveled log stored in the travel log recorder 27. In the exemplary embodiment, the traveled route information includes a traveled direction up to the current position of the 20.

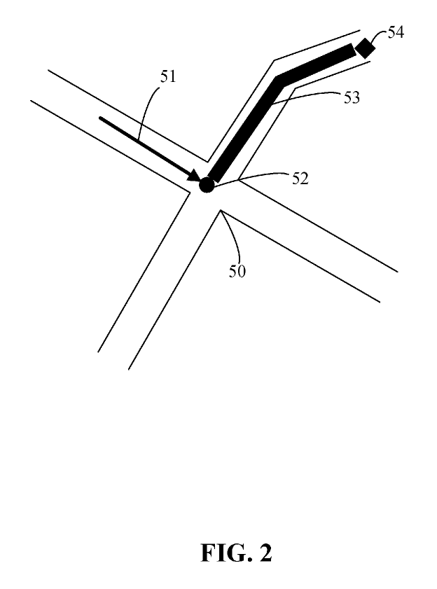

The display module 24 is used for displaying the route to the destination and the traveled route information simultaneously to more clearly show the route to the destination. Referring to FIG. 2, in the exemplary embodiment, the requested route is shown as a line 53 on an electronic map displayed by the navigation device 20. The current position 52 and the destination 54 are respectively illustrated as large dots. The traveled route information is shown as a line 51 with an arrowhead for indicating the traveled route up to the current position. Therefore, more clearly displaying a direction to advance to the destination 54 at a crossroad 50. The traveled route information makes the navigation device 20 more usable.

In other embodiment, the traveled route information may only include a latest recorded trace of the navigation device 20, the last 5 minutes for example, and the traveled route information may just be shown as a line different from the line 53 for indicating the route the navigation device traversed recently.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A navigation device, comprising:
a route generator for generating a route from a current position to a destination based on predetermined mapping data when receiving a route request;
a travel log recorder for recording a traveled log of the navigation device before receiving the route request;
a traveled route generator for generating traveled route information according to the traveled log recorded in the travel log recorder when receiving the route request; and
a display module for displaying the route and the traveled route information simultaneously for guiding a user to the destination.

2. The navigation device as described in claim 1, further comprising a storage module for storing the predetermined mapping data.

3. The navigation device as described in claim 2, further comprising a positioning module for generating information of the current position of the navigation device according to a satellite positioning signals.

4. The navigation device as described in claim 3, wherein the satellite positioning signals are sent by the Global Positioning System.

5. The navigation device as described in claim 3, wherein the satellite positioning signals are sent by the Global Navigation Satellite Systems.

6. The navigation device as described in claim 3, further comprising an input module for receiving information of the destination.

7. The navigation device as described in claim 1, wherein the traveled route information comprising a line with an arrowhead for indicating a traveled direction up to the current position.

8. The navigation device as described in claim 1, wherein the traveled route information comprising a line for indicating a route the navigation device already traversed.

9. The navigation device as described in claim 1, wherein the travel log recorder stores a latest record of the traveled log over a predetermined time period.

10. The navigation device as described in claim 1, wherein the travel log recorder stores a latest record of the traveled log over a predetermined distance.

11. A navigation device, comprising:
a travel log recorder for recording information of a preceding route of the navigation device before receiving a route request;
a route generator for generating a route from a current position to a destination based on predetermined mapping data when receiving the route request;
a traveled route generator for generating traveled route information according to information recorded in the travel log recorder when receiving the route request; and
a display module for displaying the route and the traveled route information simultaneously for guiding a user to the destination.

12. The navigation device as described in claim 11, further comprising a positioning module for generating information of the current position of the navigation device according to satellite positioning signals.

13. The navigation device as described in claim 12, further comprising an input module for receiving information of the destination.

14. The navigation device as described in claim 11, wherein the traveled route information comprising a line with an arrowhead for indicating a previously traveled direction to the current position.

15. The navigation device as described in claim 11, wherein the traveled route information comprising a line for indicating a preceding route of the navigation device.

16. A navigation method, comprising:
recording a traveled log of the navigation device before receiving a route request;
generating a route when receiving the route request comprising a destination;
generating traveled route information according to the traveled log; and
displaying the route and the traveled route information simultaneously;
wherein the route is generated based on predetermined mapping data, current position of the navigation device, and the destination.

17. The navigation method as claimed in claim 16, wherein the current position of the navigation device is generated according to satellite positioning signals.

18. The navigation method as claimed in claim 16, wherein the traveled route information comprising a line with an arrowhead for indicating a direction in which the navigation device reaches the current position.

19. The navigation method as described in claim 16, wherein the travel log recorder stores a latest traveled log recorded over a predetermined time period.

20. The navigation method as described in claim 16, wherein the travel log recorder stores a latest traveled log recorded over a predetermined distance.
